(19) United States
(12) Patent Application Publication
(10) Pub. No.: US 2003/0015673 A1
(43) Pub. Date: Jan. 23, 2003

(54) Method for detecting a transparent object and a detector device

(75) Inventor: Wolfgang Eberhard Luxem, Kiel (DE)

Correspondence Address: Lawrence P. Kessler, Patent Department, NexPress Solutions LLC, 1447 St. Paul Street, Rochester, NY, 14653-7103, US

(73) Assignee: NexPress Solutions LLC

(21) Appl. No.: 10/180,371

(22) Filed: Jun. 26, 2002

(30) Foreign Application Priority Data
Jul. 23, 2001 (DE) 101 35 766.4

(51) Int. Cl. G02F 1/01; G01N 21/86

(52) U.S. Cl. 250/559.09; 250/225

(57) ABSTRACT

Detecting a transparent object, in particular a web or conveyor belt of a printing press with at least one radiation source and at least one receiver arrangement for receiving rays from the radiation source, whereby the light intensity change based on the transparent object is independent of the position of the major optical axis h of the transparent object. A particular embodiment envisages two λ/4 small plates, which are each attached to one of two linear polarization filters, which intersect one another.

### FIELD OF THE INVENTION

The invention relates to a method and a detector device for detecting a transparent object moving in a transport path.

### BACKGROUND OF THE INVENTION

With printing presses, transparent conveyor belts or webs are often used, which convey the printing stock through the printing press. The proper position of the web within low tolerance limits is of particular importance for error-free printing. If the web of the printing press is moved, the conveyed stock is also correspondingly moved and the printing is carried out in a shifted position. It is thus desirable to determine and control the position of the web.

For such purpose, optical sensors may be provided, whereby the detection of transparent material by light beams still presents particular problems, since the reflectivity of the transparent material is limited, and the difference between the light shining through the transparent web to the light receiver and the light detected directly by the light receiver is small. Known solutions are costly and require sensitive detectors. Another problem is the soiling of and surface damages to the transparent web, whereby optical measuring procedures due to the change of the ray path cause considerable damage.

Furthermore, with solutions involving optical sensor devices, there is the problem that the ray path of the light beams with slightly unwanted change in the position of the major optical axis h based on the forward direction of the polarization filter of the transparent web is already considerably changed in such a way that the measuring procedure cannot be used without adjustment of the alignment of the optical transmitter.

### SUMMARY OF THE INVENTION

The purpose of this invention is thus to provide a cost-effective, reliable and simple detector device and a method to detect transparent objects. For this purpose, detecting a transparent object by a polarized light that has experienced an intensity change of its light intensity during its passage through the transparent object is provided. The intensity change is detected, which is independent of a major optical axis position φ, which is also referred to below simply as major optical axis position φ of the transparent object. Furthermore, a detector device is provided with at least one radiation source and at least one receiver arrangement for receiving rays from the radiation source by a circular polarimeter. In this manner then, a transparent object can also be correctly measured or detected when the transparent object is not located in its ideal position. The measurement or detection independent of the major optical axis position φ is particularly easy and advantageous if two respective retardation plates (circular polarimeter) each attached to a linear polarization filter with a quarter wavelength retardation difference, which is also know as λ/4 small plate, are provided. As such polarization filters intersect one other, i.e., the forward direction of both linear polarization filters for radiation is offset at 90° to one another.

The invention and its advantages will be better understood from the ensuing detailed description of preferred embodiments, reference being made to the accompanying drawings in which like reference characters denote like parts.

### BRIEF DESCRIPTION OF THE DRAWINGS

In the detailed description of the preferred embodiment of the invention presented below, reference is made to the accompanying drawings, in which:

FIG. 1 shows a schematic front view of a detector device with a radiation source and a receiver arrangement, to each of which a polarization filter is attached, a transparent object with an ideal major optical axis position φ and an intensity diagram of the radiation detected by the receiver arrangement;

FIG. 2 shows a detector device similar to the one in FIG. 1 with a non-ideal major optical axis position φ;

FIG. 3 shows a schematic front view of the invention with a detector device with a radiation source and a receiver arrangement, to which each of which a polarization filter and a λ/4 small plate is attached, as well as with a transparent object with a desirable major optical axis position φ; and

FIG. 4 shows a principal arrangement with respect to the invention, whereby the radiation vectors are qualitatively represented.

### DETAILED DESCRIPTION OF THE INVENTION

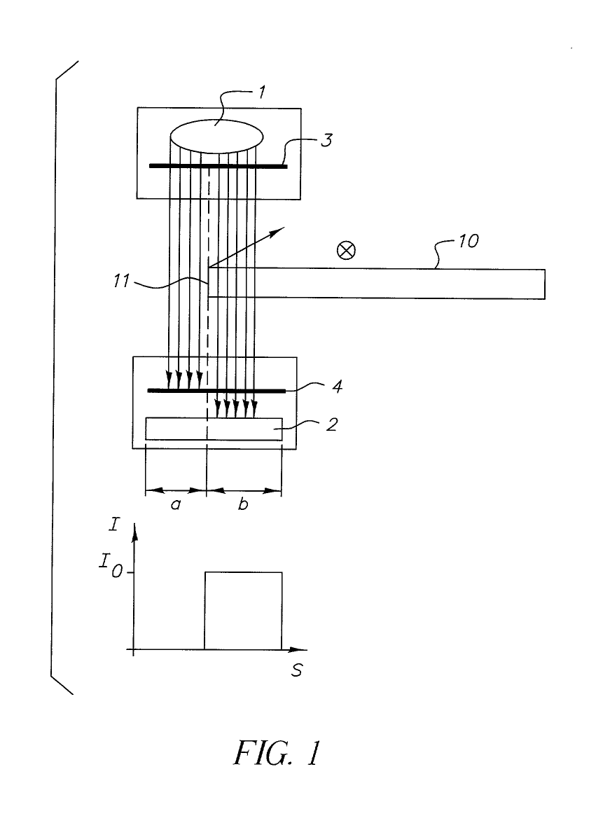

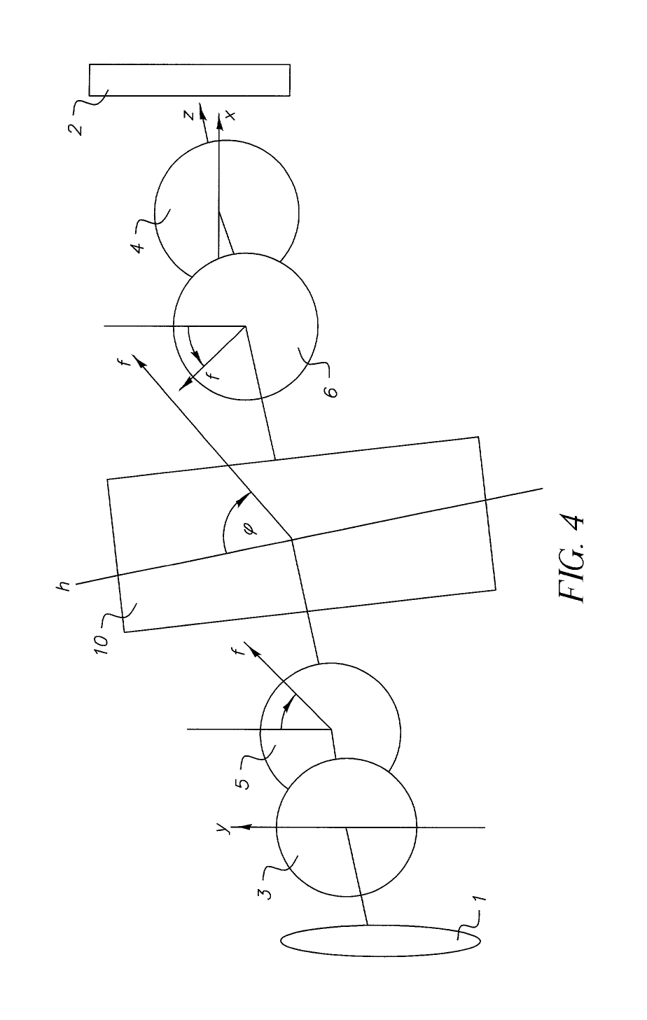

FIG. 1 shows a schematic representation of the invention with a transparent object 10 with a major optical axis h corresponding to that shown in FIG. 4. The transparent object 10 may be, for example, a conveyor belt or web of a printing press. A radiation source 1 and a first linear polarization filter 3 are located above the transparent object 10. Furthermore, a receiver arrangement 2 and a second polarization filter 4 are arranged below the transparent object 10. The radiation source 1 and the receiving arrangement 2 are partially separated by the transparent object 10, and one portion of the radiation path of the radiation source 1 hits the transparent object 10 after passing through the first polarization filter 3 and the other part passes to the second polarization filter 4. The operating principle of the configuration according to FIG. 1 is explained below. The radiation source throws light rays, which are symbolically represented in the figure as lines with arrowheads, which are indicated pointing in the direction of the radiation path, and in the direction of the receiver arrangement 2, which, with the radiation source 1 pass through a linear polarization filter 3 and are linearly polarized. The now polarized light of the light source 1 spreads further in the direction of the arrowheads and one portion hits a transparent object 10. The other portion of the light travels past the transparent object 10 and strikes a second linear polarization filter 4, which intersects the first polarization filter 3, i.e., the polarization directions and the alignment of the axis of the transmitted light of both the linear polarization filters 3, 4, are shifted by 90° to one another.

This means that the light beams that pass through the first polarization filter 3, cannot be transmitted by the second polarization filter 4, as illustrated by the arrows to the left. Considered from the standpoint of the light source 1, the receiving arrangement 2 behind the second polarization filter 4 receives no radiation from the radiation source 1 in the area a. As illustrated by the arrows to the right, a portion of the radiation of the radiation source 1 hits the transparent object 10. The transparent object 10 in this example is an infinite transparent conveyor belt or web of a printing press that is driven in the direction of the pointing arrows in the observer plane and which conveys the stock through the printing press. A small portion of the radiation hitting the transparent object 10 is reflected, as indicated by the arrows tilted upward at the transparent object 10. However, the larger portion of the radiation is transmitted through the transparent object 10. The transparent object 10 acts as a polarization filter for the light rays. The light intensity of the radiation of the radiation source 1 after passing through the transparent object 10 can be calculated according to the following formula:

$$I = {sin}^{2} \frac{( Δ )}{( 2 )} {sin}^{2} ( 2 ϕ ) \qquad ( Equation 1 )$$

In this formula, I is the intensity of the light, Δ indicates the phase retardation of the radiation during the passage of the transparent object 10 based on the double refraction of the transparent object 10 and φ indicates the position of the major optical axis h of the transparent object 10 based on the forward direction of the polarization filter 3, 4. In the above formula, there is a maximum light intensity of:

$$I = {sin}^{2} \frac{( Δ )}{( 2 )} {sin}^{2} ( 2 ϕ ) \qquad w i t h a n a n g l e o f ϕ e q u a l t o 45 ° ,$$

and the major optical axis set in FIG. 1 amounts to φ equal to 45°, whereby an optimum of the light intensity during the passage of the radiation through the transparent object 10 occurs. If the major axis h is parallel (or almost parallel) to the forward direction of one of the two polarization filters 3, 4, then no change or only a very small change of the polarization condition of the incident light is achieved. In the example in FIG. 1, an optimal passage of the radiation and an optimal maximum light intensity I behind the transparent object 10 is given with a major optical axis position of φ=45°. The radiation of the radiation source 1 further experiences a change in its polarization condition due to the optical polarization characteristics of the transparent object 10.

The radiation then hits the second linear polarization filter 4, which intersects the first polarization filter 3, i.e., the polarization filter 4 allows light that has a defined position of the oscillation plane to pass through, whereby the oscillation plane is offset 90° from the oscillation plane of the first polarization filter 3. In this case, the radiation is transmitted through the second polarization filter 4, because the polarization condition of the radiation in the transparent object 10 is changed. In area b of the receiver arrangement 2, a greater portion of light from the radiation source 1 hits the receiver arrangement and is detected. The light intensity I in the figures is symbolically and qualitatively represented by the density of the direction arrows. The receiver arrangement 2 contains a row of diodes or a CCD (charge-coupled device) component. Between the areas a and b of the receiver arrangement, there is thus a jump in intensity of a light intensity I from an ideal zero to a light intensity I according to Equation 1, as indicated qualitatively in the light intensity/path diagram according to FIG. 1. With vertical incidence of the light from the radiation source 1, the edge 11 of the transparent object 10 is located above the light intensity jump or contrast.

The process described above requires that the major optical axis position of the transparent object 10 be approximately φ equals 45°, otherwise, the light intensity I and the contrast between areas a and b decreases according to Equation 1, and, as a result, the transparent object 10 is less clearly detected. The change in the major optical axis position φ, causes problems, somewhat due to stress on the transparent object 10 or due to different values of the major optical axis position φ at various places on the transparent object 10. The optical characteristics and the stresses on the transparent object 10 are largely determined by the manufacturing process. The optical characteristics of the transparent object 10 may have wide local deviations, causing a variation of the optical characteristics in the length and width of the transparent object 10. Spoiling of the surface of the transparent object 10 also reduces the light transmitted locally and impairs the signal-to-noise ratio of the receiver arrangement 2. Consequently, a measurement that is carried out as stated above is not totally reliable.

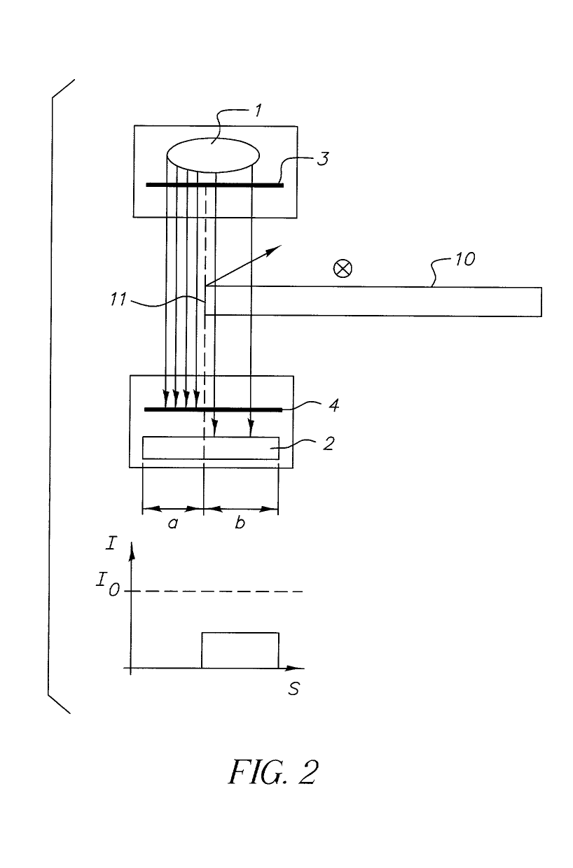

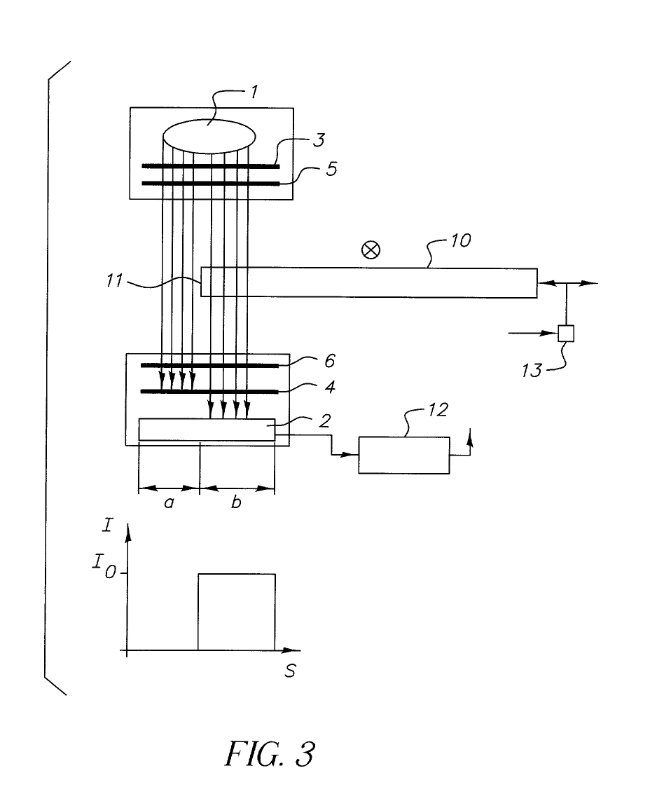

One possible remedy for this situation is to adjust the polarization filters 3, 4, i.e., the position of major optical axis h of the transparent object 10 based on the forward direction of the polarization filters 3, 4 according to Equation 1, in order to set a higher light intensity I. This is achieved by rotating the polarization filters 3, 4, although only in a limited angle range. Another problem is that the major optical axis position φ of the transparent object 10 is rarely defined and the light intensity I can only be set by trial and error. The problem is pictorially illustrated beforehand in FIG. 2. A solution of the above problem is described below based on FIG. 3.

FIG. 2 shows a schematic detector device similar to FIG. 2 with the difference that the major optical axis position φ is not equal to 45° as desired, or is not ideal. The light intensity I according to Equation 1 is considerably reduced with the passage of radiation through the transparent object 10, as illustrated by a reduced density of the direction arrows below or according to the transparent object 10. The striking and detectable radiation is reduced in comparison with FIG. 1, as shown by the light intensity/path diagram according to FIG. 2, so that the contrast between areas a and b is reduced and the edge 11 of the transparent object 10 is less detectable than in FIG. 1.

In order to increase the contrast between areas a and b, FIG. 3 shows a schematic embodiment of a detector device with a radiation source 1 and a receiver arrangement 2. As in FIG. 2, the light emitted from the radiation source 1 is first linearly polarized by the first polarization filter 3. Unlike the previous example, the light subsequently passes through a retardation plate (circular polarimeter) with a quarter wavelength radiation difference, subsequently called the first λ/4 small plate 5. The first λ/4 small plate 5 causes the polarized light from the first polarization filter 3 to be polarized circularly. Next, as in the case according to FIG. 1, the radiation path of the light splits into two, during which the radiation path represented by the left arrows in FIG. 2 hits the circularly polarized light at a second λ/4 small plate 6, in which the light is linearly polarized. Next, the linearly polarized light hits the second linearly polarized filter 4, whereby the light without further outside influences is not transmitted by the second linearly polarization filter 4, similar to the case in FIG. 1. The light intensity/path diagram according to FIG. 3 consequently shows a light intensity of zero in the area a of the receiver arrangement 2. In the second case according to FIG. 3, following the circular polarization in the first λ/4 small plate 5 in the area of the edge 11, the light hits the transparent object 10, whose major optical axis position φ is not equal to 45° due to stresses. However, the light intensity I in front of and behind the transparent object 10 remains in this case almost constant, and there is no considerable reduction due to the non-ideal position of the major optical axis h of the transparent object 10. This phenomenon is explained below. By the circular polarization of the radiation in the first λ/4 small plate 5, the following formula Equation 2 for the light intensity I after the passage through the transparent object 10 is obtained after some conversion of Equation 1:

$$I = {cos}^{2} \frac{( Δ )}{( 2 )} \qquad ( Equation 2 )$$

In Equation 2, there is no expression for the major optical axis position φ as in Equation 1, which means that the light intensity I according to Equation 2 and according to FIG. 3 is independent of the major optical axis position φ. The light intensity I is only dependent on the phase retardation Δ of the radiation during the passage through the transparent object 10. The phase retardation is measured in the receiver arrangement 2 and converted by Equation 2 into a light intensity I. From this statement, it can be understood that the intensity/path diagram according to FIG. 3, despite a major optical axis position φ that is not equal to 45° in the area b, has a high light intensity I, as indicated by the comparable value Iₒ in the light intensity/path diagram in FIG. 3, which is roughly identical to the value when an ideal major optical axis position φ according to Equation 1 is used. Finally, the invention makes it possible, without having to compensate for light intensity losses, to precisely detect and evaluate a transparent object 10, independent of stresses and changes in the transparent object 10, which, as described, change the position of the major optical axis h of the transparent object 10 based on the forward direction of the polarization filters 3, 4. The receiver arrangement 2 produces a signal, which is based on the detected light intensity and where the intensity change is located. Such signal is sent from the receiver arrangement 2 to a computer 12 which can then determine, from the signal, the location of the transparent object 10. A signal from the computer 12 can be sent to a device 13 to correct position errors of the transparent object 10.

In conclusion, FIG. 4 explains the above-described facts by an illustration from another perspective. The reference marks indicate the same characteristics as in FIGS. 1-3. The radiation is linearly polarized in the direction of the y-axis in the first polarization filter 3. Subsequently, the radiation in the first λ/4 small plate 5 is circularly polarized, and the quick-acting axis f of the radiation is tilted by 45°. During the passage through the transparent object 10, the polarization condition is changed as a function of the position of the major axis h of the transparent object 10, which is determined by the characteristics of the transparent object 10. The circular polarization is canceled by the second λ/4 small plate 6, and the quick-acting axis f is tilted by 45°. Then the radiation in the second linear polarization filter 4 is polarized in the direction of the x-axis and received in the receiver arrangement 2. In FIG. 4, only the case is described in which the radiation is transmitted by the transparent object 10. The other case, in which the radiation passes by the transparent object 10 is described under FIGS. 1-3. In FIG. 4, it can be seen that during the change of the major axis h, the quick-acting axis f of the radiation is also changed, if the angle φ is constant.

The invention has been described in detail with particular reference to certain preferred embodiments thereof, but it will be understood that variations and modifications can be effected within the spirit and scope of the invention.

What is claimed is:

1. Method for detecting a transparent object (10) by a polarized light that experiences a change in intensity of its light intensity while passing through the transparent object (10), characterized in that the change in intensity is detected, which is independent of a major optical axis position of the transparent object (10), by the sending of light rays from a radiation source (1), polarization of the light radiation in a first linear polarization filter (3), shifting of the polarization plane of the light rays by a quarter of the wavelength of the light, passage of a transparent object (10) through a portion of the light rays, polarization of the light rays in a second linear polarization filter (4), shifting of the polarization plane of the light rays by a quarter of the wavelength of the light, reception and evaluation of the light rays in a receiver arrangement (2).

2. Method according to claim 1, characterized by calculation of the position of the transparent object (10) on the basis of light rays received and evaluated in the receiver arrangement (2).

3. Method according to claim 2, characterized by automatic correction of position errors of the transparent object (10) on the basis of the results of the calculation steps.

4. Detector device, with at least one radiation source (1) and at least one receiver arrangement 2 for receiving rays from a radiation source (1), characterized by a pair of λ/4 small plates (5, 6) each of which are attached to a pair of linear polarization filters (3, 4), respectively, intersecting one another, whereby said first λ/4 small plate (5) is inserted after said first polarization filter (3) and said second λ/4 small plate (6) is arranged in front of said second polarization filter (4).

5. Detector device according to claim 4, characterized in that the position of the transparent object (10) can be determined with a computer (12).
